(19) United States
(12) Patent Application Publication
(10) Pub. No.: US 2019/0380889 A1
(43) Pub. Date: Dec. 19, 2019

(54) FLEXIBLE DISPOSABLE STRETCHER

(71) Applicant: Little Rapids Corporation, Green Bay, WI (US)

(72) Inventors: Gerald T. Paul, Whitelaw, WI (US); David M. Ledvina, Luxemburg, WI (US); Joe Pulvermacher, Fitchburg, WI (US); Michael Wright, Milwaukee, WI (US)

(73) Assignee: Little Rapids Corporation, Green Bay, WI (US)

(21) Appl. No.: 16/008,283

(22) Filed: Jun. 14, 2018

(51) Int. Cl. A61G 1/01; A61G 1/044

(52) U.S. Cl. CPC A61G 1/01; A61G 1/044

(57) ABSTRACT

A flexible stretcher having skid plate webbing connected to a surface of the stretcher. The stretcher includes a flexible body with a first surface and a second surface. Skid plate webbing connects to the second surface. In another embodiment, the stretcher has a flexible body with a rectangular shape extending lengthwise in a longitudinal direction. The flexible body has a first surface and a second surface. Structural webbing and skid plate webbing connect to the second surface. The skid plate webbing at least partially overlaps the structural webbing, and where the overlapping occurs, contact points are formed. In another embodiment, a flexible stretcher having a body with a rectangular shape extending lengthwise in a longitudinal direction, a first surface, and a second surface, may be manufactured by attaching structural webbing to the body and attaching skid plate webbing to the second surface of the body.

### FIELD OF THE INVENTION

The present invention relates to the field of medical equipment, and in particular to stretchers.

### BACKGROUND

During emergency or tactical situations, ease of mobility can be one of many valued assets, and equipment durability can be another. When a user needs to maneuver through an emergency situation with a piece of tactical equipment, it is often desirable for the equipment to be readily transportable in a manner that minimizes hindrances to the user's mobility and maximizes the valuable use-life of the equipment.

This disclosure relates to improvements to existing systems and to solutions to some of the issues raised or not solved thereby.

### SUMMARY

The present disclosure relates to a flexible stretcher having skid plate webbing. According to one aspect of the present disclosure, the stretcher has a flexible body. The flexible body has a first surface and a second surface. Skid plate webbing is connected to the second surface.

According to another aspect of the present disclosure, the stretcher has a flexible body. The body has a first surface and a second surface. Structural webbing and skid plate webbing are connected to the second surface. The skid plate webbing at least partially overlaps the structural webbing, and where the overlapping occurs, contact points are formed.

According to another aspect of the present disclosure, the stretcher has a flexible body with a rectangular shape. The body has two longer, lateral sides, two shorter, end sides, a first surface, and a second surface. Structural webbing is connected to the second surface and includes a plurality of structural webbing straps positioned in an X shape. At least one of the structural webbing straps extends beyond the body. Skid plate webbing is also connected to the second surface. The skid plate webbing at least partially overlaps the structural webbing and includes a plurality of skid plate webbing straps positioned parallel to the longer, lateral sides of the rectangular body. At least one of the skid plate webbing straps extends beyond the body. Further, one or more contact points are formed where the skid plate webbing overlaps the structural webbing. Additionally, at least one handle component is located on each of the structural webbing straps that extends beyond the body, and at least one handle component is located on each of the skid plate webbing straps that extends beyond the body.

A flexible stretcher having a first surface and a second surface may be manufactured according to one aspect of the present disclosure by attaching structural webbing to the body and thereafter attaching skid plate webbing to the second surface of the body.

Other objects and advantages of the present disclosure will become apparent hereinafter.

### DESCRIPTION OF THE DRAWING

FIG. 1 is a perspective view of a stretcher, according to one embodiment of the present disclosure, showing a single user dragging the stretcher.

FIG. 2 is a perspective view of the stretcher of FIG. 1 showing multiple users dragging the stretcher.

FIG. 2A is a perspective view of a user carrying the stretcher of FIG. 1 on the user's back.

FIG. 3 is a top perspective view of the stretcher of FIG. 1.

FIG. 4 is a top view of the stretcher of FIG. 1.

FIG. 5 is a top view of the stretcher of FIG. 1 showing a configuration of straps, according to one manner of use.

FIG. 6 is a bottom perspective view of the stretcher of FIG. 1.

FIG. 7 is a bottom view of the stretcher of FIG. 1.

FIG. 8 is an exploded perspective view of the stretcher of FIG. 1.

FIG. 9 is a detail perspective view of the stretcher shown in FIG. 6, according to one embodiment of the present disclosure, showing a pattern of stitches on the stretcher.

FIG. 10 is a perspective view of a stretcher, according to another embodiment of the present disclosure, showing multiple users carrying the stretcher.

FIG. 11 is a top perspective view of the stretcher of FIG. 10 showing a configuration of straps, according to one manner of use.

FIG. 12 is a top view of the stretcher shown in FIG. 11.

FIG. 13 is a top view of the stretcher of FIG. 10 showing another configuration of straps, according to another manner of use.

FIG. 14 is a top perspective view of the stretcher of FIG. 10 showing another configuration of straps, according to another manner of use.

FIG. 15 is a top view of the stretcher shown in FIG. 14.

FIG. 16 is a bottom perspective view of the stretcher of FIG. 10.

FIG. 17 is a bottom view of the stretcher of FIG. 10.

FIG. 18 is an exploded perspective view of the stretcher of FIG. 10.

FIG. 19 is a detail perspective view of the stretcher shown in FIG. 16, according to one embodiment of the present disclosure, showing a pattern of stitches on the stretcher.

### DETAILED DESCRIPTION

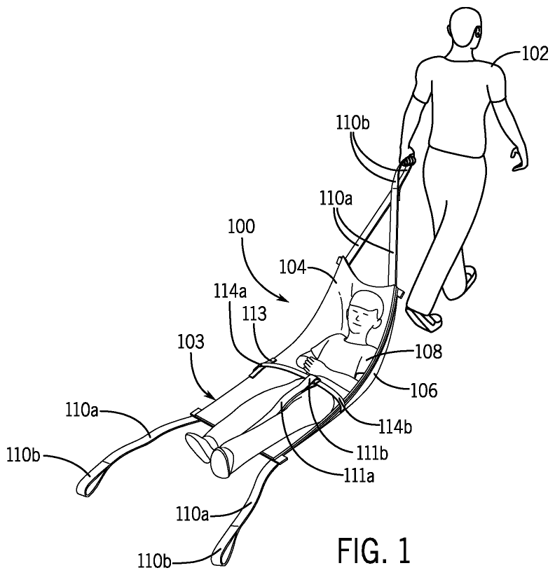

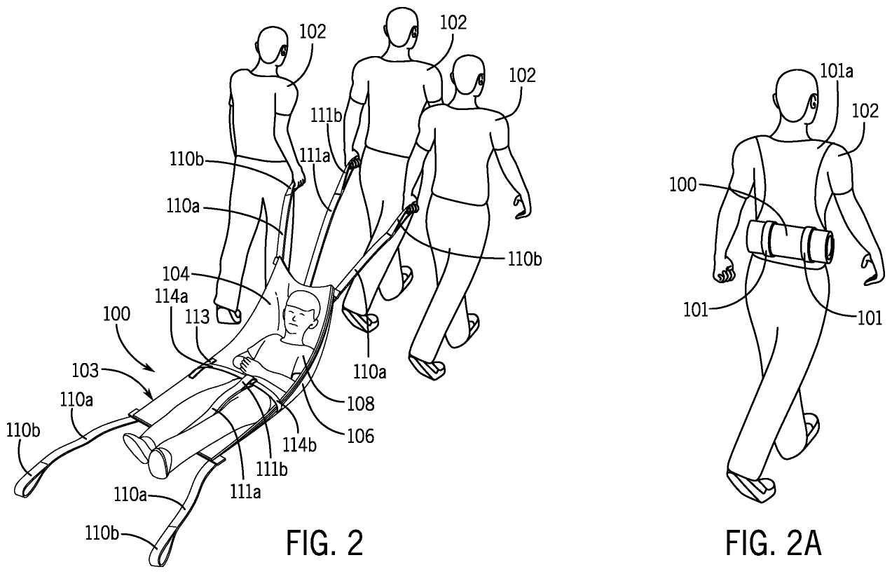

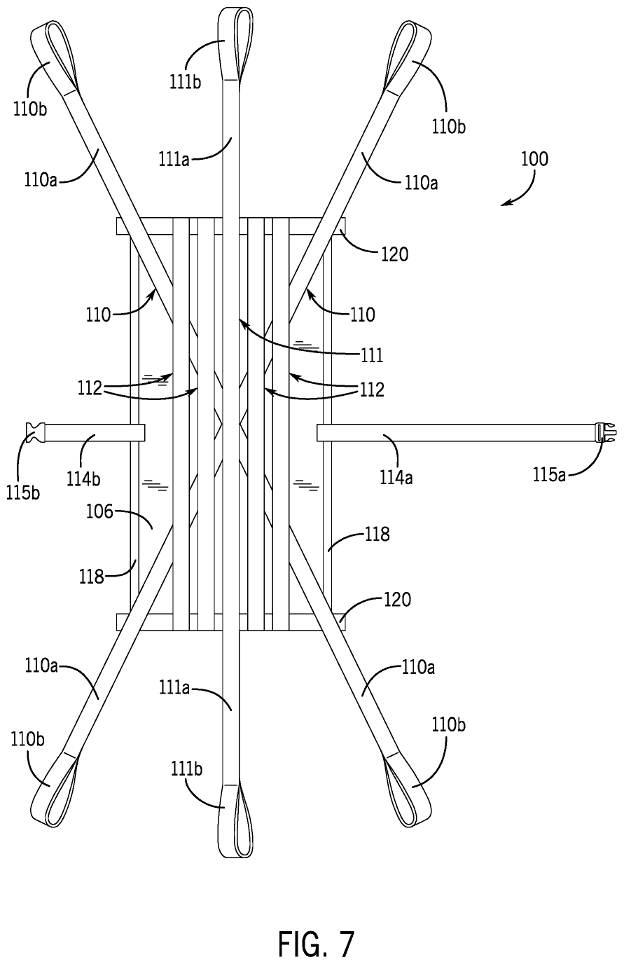

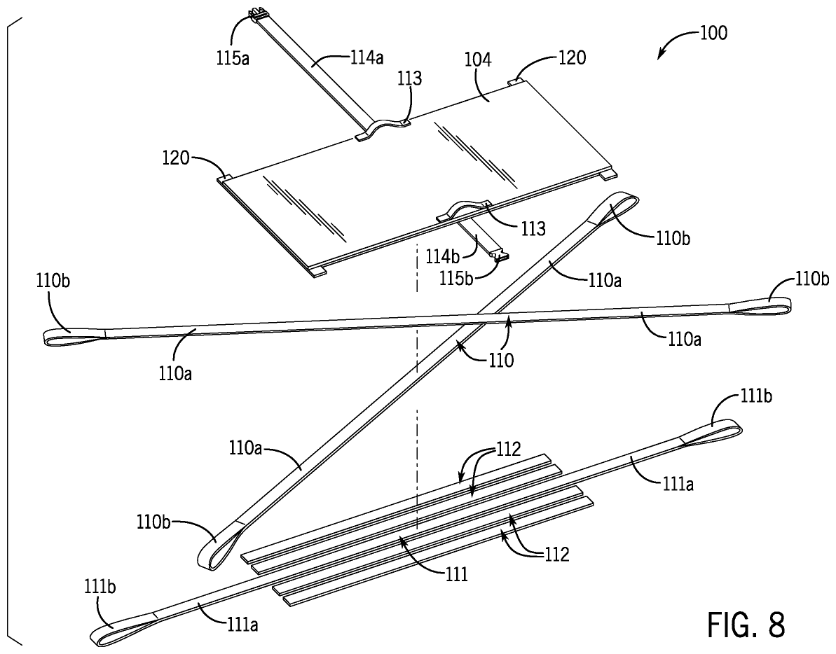

One aspect of the present disclosure provides a flexible stretcher having skid plate webbing attached to the stretcher. Referring now to FIGS. 1-9, there is shown a stretcher 100 having a flexible body 103. In certain embodiments, the stretcher 100 may be used as a single event device, meaning that the stretcher 100 may be disposed of after each event during which the stretcher 100 is used. However, in other embodiments, the stretcher 100 need not be disposable. Prior to use, according to some embodiments, the stretcher 100 is capable of being condensed into a compact, lightweight roll, as shown in FIG. 2A. According to other embodiments, the stretcher 100 may be condensed by other means, such as folding. In the embodiment shown, when rolled, the stretcher 100 is sized to fit within a set of external straps 101 of a first responder vest 101a. In other embodiments, the stretcher 100 may attach in a similar manner to a responder backpack or to a different piece of responder equipment. Alternatively, other attachment means may be used to secure the stretcher 100 to the piece of responder equipment.

During ordinary use, the body 103 includes a top surface 104 and an opposing, bottom surface 106, the top surface 104 supporting a victim 108. Outside of ordinary use, for instance when rolled or otherwise packaged, the top and bottom orientations may vary. Where the phrases “top surface” and “bottom surface” appear in this application, these phrases refer to the ordinary use orientation described above.

In the embodiment shown in FIGS. 1-9, the stretcher 100 further includes handle extensions 110a, 111a and side handles 113. As shown in FIGS. 1-2, when the stretcher 100 is in use, at least one user 102 may drag the stretcher 100 by the handle extensions 110a, 111a. Further, in the embodiment shown, each handle extension 110a, 111a includes a handle component 110b, 111b that the user 102 may grip when dragging the stretcher 100. Alternatively, the user 102 may carry the stretcher 100 by the side handles 113, attached to the body 103. In the embodiment shown, the side handles 113 are stitched to the top surface 104.

FIG. 1 shows one user 102 dragging the stretcher 100 by two of the handle extensions 110a. Alternatively, FIG. 2 shows three users 102 dragging the stretcher 100 by three of the handle extensions 110a, 111a, two users respectively pulling two handle extensions 110a and a third user pulling one handle extension 111a. Additional combinations of users 102 and/or handle extensions 110a, 111a may be capable of, and usable for, transporting the stretcher 100. In the embodiment shown in FIGS. 1-2, the victim 108 is secured to the top surface 104 by a first securing strap 114a and a second securing strap 114b. The first and second securing straps 114a, 114b each have a first longitudinal end and a second longitudinal end. The first longitudinal ends of the first and second securing straps 114a, 114b are connected to the body 103.

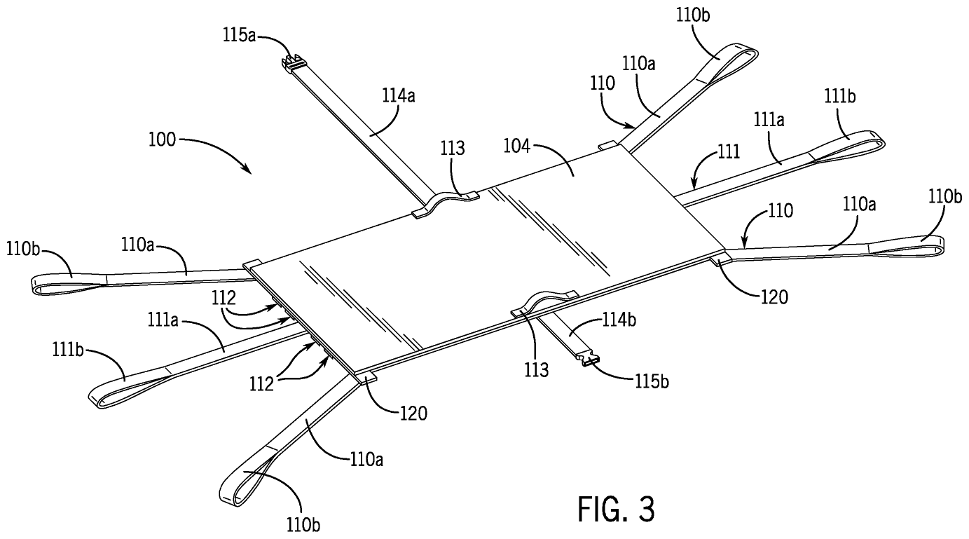

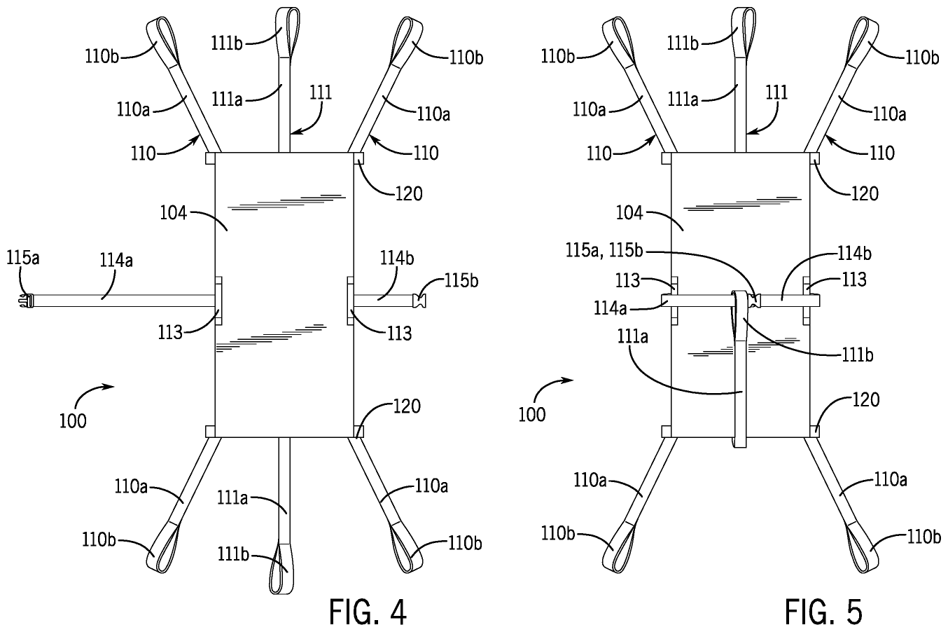

FIGS. 3-5 show the first and second securing straps 114a, 114b in both an unsecured position (shown in FIGS. 3-4) and a secured position (shown in FIG. 5). In the embodiment shown, a first buckle component 115a is attached to the second longitudinal end of the first securing strap 114a, and a corresponding, second buckle component 115b is attached to the second longitudinal end of the second securing strap 114b. In this embodiment, the first and second securing straps 114a, 114b are brought into the secured position by mating the first buckle component 115a with the second buckle component 115b. However, in other embodiments, other means of bringing the first and second securing straps 114a, 114b into a secured position may be employed.

Additionally, as shown in FIGS. 1-2, one of the handle extensions 111a may be brought between a pair of legs of the victim 108 and connected to the first and second securing straps 114a, 114b to further secure the victim 108 in place on the top surface 104. In the embodiment shown, at least one of the first and second securing straps 114a, 114b passes through the handle component 111b, connected to the handle extension 111a, before the first and second securing straps 114a, 114b enter the secured position. In other embodiments, the handle extension 111a may connect to the first and second securing straps 114a, 114b by other connection means.

FIGS. 3-5 further show the top surface 104 in greater detail. In the embodiment shown, four handle extensions 110a and two handle extensions 111a extend from underneath the body 103. In other embodiments, a different number of handle extensions 110a, 111a may be included. Further, in this embodiment, only a single handle component 110b, 111b is included on each handle extension 110a, 111a, and the handle component 110b, 111b is positioned at a longitudinal end of the respective handle extension 110a, 111a. However, in other embodiments, a given handle extension 110a, 111a may include a different number of handle components 110b, 111b, and the handle components 110b, 111b may be positioned in alternate locations, such as along the length of a given handle extension 110a, 111a. In the embodiment shown, each of the handle extensions 110a, 111a is folded over at a longitudinal end to generate a loop, forming the respective handle component 110b, 111b. Although, in other embodiments, one or more of the handle components 110b, 111b may take another form, such as a separate handle extension comprised of foam or webbed material.

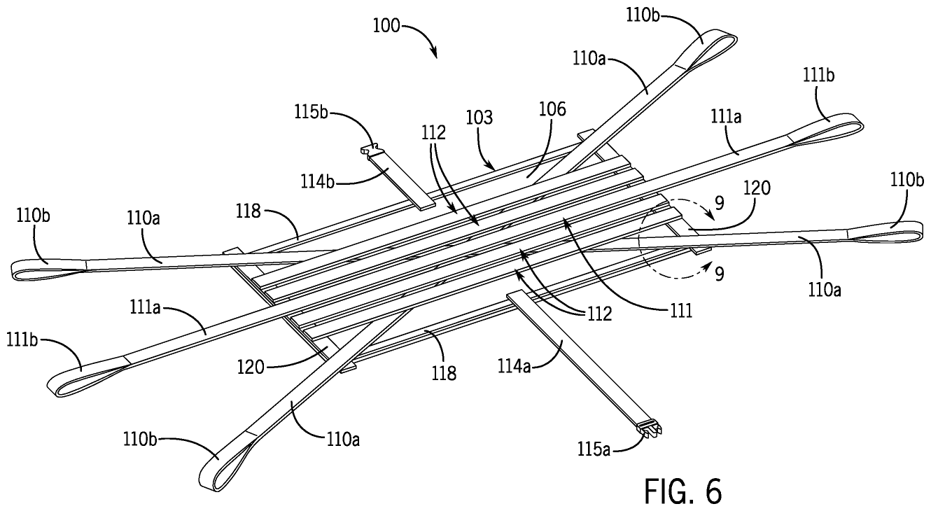

FIGS. 6-9 show the bottom surface 106 in greater detail. In the embodiment shown, the body 103 is relatively rectangular, having a pair of opposing long side edges and a pair of opposing short side edges. A side perimeter strap 118 attaches to each of the long side edges and a cross perimeter strap 120 attaches to each of the short side edges. In reference to the shape of the body 103, the above reference to it being rectangular can be considered for reference purposes only so that, in certain embodiments, the bottom surface 106 may take on a non-rectangular shape, and alternative or additional perimeter straps may be attached to alternative or additional edges. In the embodiment shown, the side and cross perimeter straps 118, 120 are stitched to the bottom surface 106, although in other embodiments, other attachment means may be employed. In the embodiment shown in FIGS. 6-8, the first and second securing straps 114a, 114b are stitched to the bottom surface 106 and to the side perimeter straps 118 where the first and second securing straps 114a, 114b intersect the side perimeter straps 118. In alternative embodiments, the first and second securing straps 114a, 114b may connect to the body 103 by means other than stitching.

In some embodiments, structural webbing is further included on the body 103. In the embodiment shown in FIGS. 1-9, the structural webbing is comprised of a pair of straps 110 positioned in an X shape, connected to the bottom surface 106. In this embodiment, the straps 110 are partially stitched to the bottom surface 106 and partially extend beyond the bottom surface 106, forming the handle extensions 110a. In other embodiments, one or more of the structural webbing straps 110 may be confined to the body 103, without extending further. Additionally, in certain embodiments, the structural webbing straps 110 may be arranged in a different configuration, rather than an X shape.

Returning to the embodiment shown in FIGS. 1-9, skid plate webbing 111, 112 is shown connected to the bottom surface 106. In the embodiment shown in FIGS. 6-9, the skid plate webbing 111, 112 is arranged as a series of straps, each approximately two inches wide at approximately one inch spacing, positioned longitudinally along the bottom surface 106. In alternate embodiments, the skid plate webbing 111, 112 may vary in width and spacing. For instance, the skid plate webbing 111, 112 may be formed of approximately one-and-a-half inch straps at approximately three-quarter inch spacing. Regardless of the shape of the body 103 or the specific dimensions of the skid plate webbing 111, 112, the longest dimension of the webbing extends in the direction that the stretcher 100 is dragged during ordinary use, when bearing a victim 108.

Like the structural webbing 110, the skid plate webbing 111, 112 may either be confined to the bottom surface 106 or extend beyond the bottom surface 106. In the embodiment shown, one strap 111 of the skid plate webbing extends beyond the bottom surface, forming the handle extensions 111a, whereas the remaining straps 112 of the skid plate webbing remain confined to the bottom surface 106. In this embodiment, there is one extended skid plate webbing strap 111a and four confined skid plate webbing straps 112, two on either side of the skid plate webbing strap 111. However, in other embodiments, the number of extended skid plate webbing straps 111 and confined skid plate webbing straps 112 may vary, along with the order in which the skid plate webbing straps 111, 112 are positioned relative to one another. In the embodiment shown, the skid plate webbing 111, 112 is stitched over the structural webbing 110, maximizing the ease with which the stretcher 100 may be dragged along a ground surface and minimizing damage to the structural webbing 110 as the stretcher is dragged.

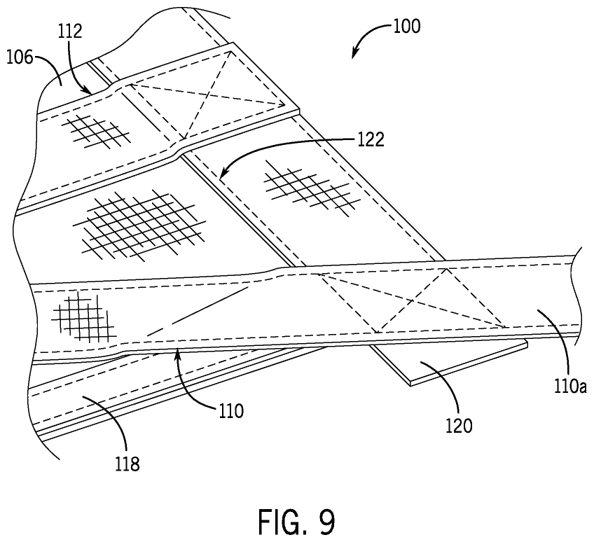

As referenced above, in the embodiment shown in FIGS. 6-9, the handle extensions 110a, 111a are shown as continuous extensions of the connected portions of the structural and skid plate webbing 110, 111. In this embodiment, the skid plate webbing 111, 112 is connected to the bottom surface 106 by stitching. The stitching 122 at a corner of the bottom surface 106 is shown in detail in FIG. 9. Here, a portion of the skid plate webbing 112 is shown stitched to the bottom surface 106 and to the cross perimeter strap 120 where the skid plate webbing 112 intersects the cross perimeter strap 120. Additionally, a portion of the structural webbing 110 is shown, the structural webbing 110 stitched to the bottom surface 106, and to the side perimeter strap 118 and the cross perimeter strap 120 where the structural webbing 110 intersects the side and cross perimeter straps 118, 120, respectively. In an alternative embodiment, the elements stitched to the bottom surface 106 in this embodiment may be connected to the body 103 by means other than stitching. In a further alternative, the handle extensions 110a, 111a may be discrete elements, independently attached to the body 103, rather than continuous extensions of the structural and skid plate webbing 110, 111. For example, the handle extensions 110a, 111a may be stitched, or otherwise attached, directly to one or both of the surfaces 104, 106, to one or both of the forms of webbing 110, 111, to one or both of the perimeter straps 118, 120, or to any combination thereof.

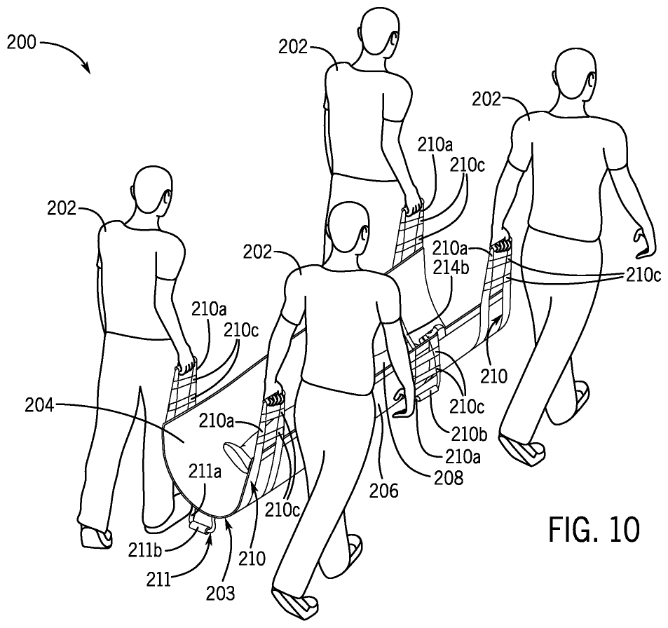

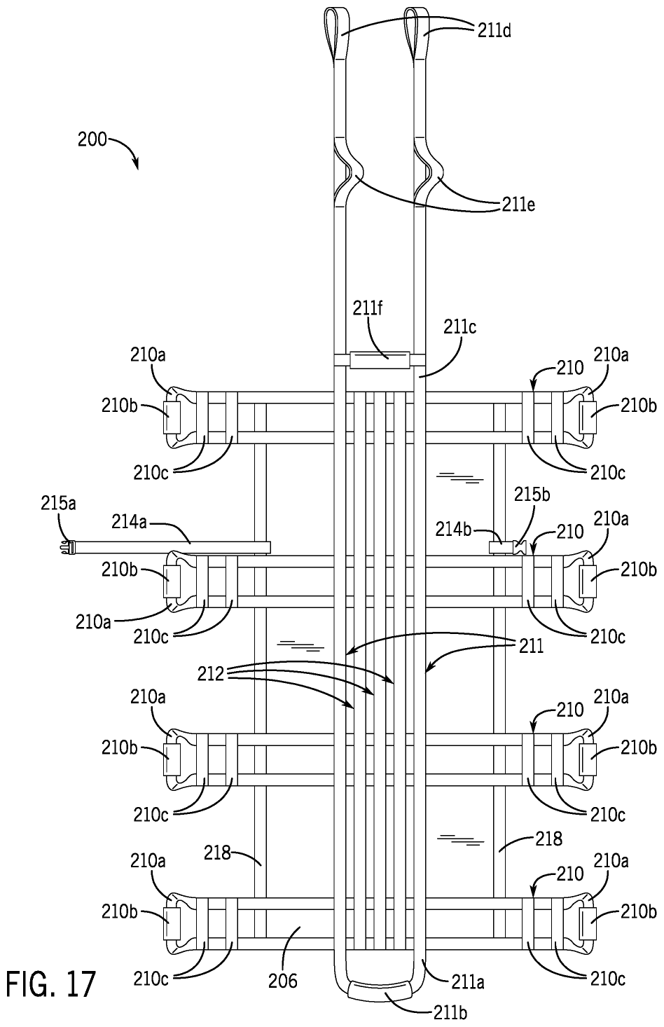

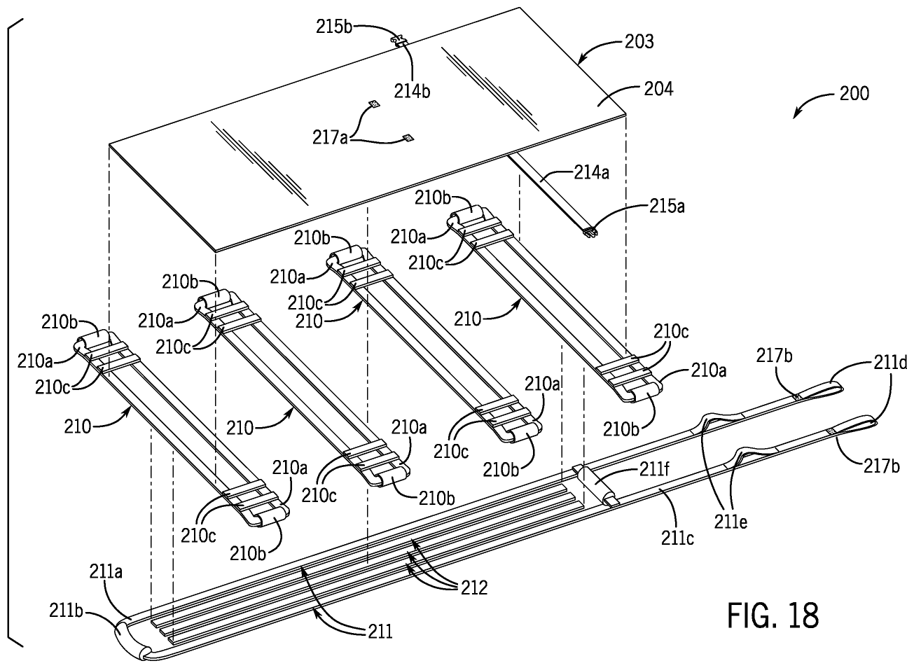

Turning to an alternative embodiment of the present disclosure, FIGS. 10-19 show a stretcher 200 having a flexible body 203. Like certain embodiments of the stretcher 100, the stretcher 200 may also be used as a single event device. Alternatively, the stretcher 200 may be reused over the course of multiple events.

During ordinary use, the body 203 includes a top surface 204 and an opposing, bottom surface 206, the top surface 204 supporting a victim 208. Outside of ordinary use, for instance when packaged, the top and bottom orientations may vary.

Where the phrases “top surface” and “bottom surface” appear in this application, these phrases refer to the ordinary use orientation described above.

In the embodiment shown in FIGS. 10-19, the stretcher 200 further includes handle extensions 210a, 211a, 211c. As shown in FIG. 10, when the stretcher 200 is in use, a user 202 may carry the stretcher 200 by handle extensions 210a, 211a, 211c. In the embodiment shown, each of the handle extensions 210a includes a handle component 210b and an intermediate handle component 210c that the user 202 may grip when carrying the stretcher 200. In this embodiment, the handle extension 211a includes a handle component 211b, and the handle extension 211c includes a handle component 211f. Respective users 202 may grip the handle components 211b, 211f when carrying the stretcher 200. As an alternative to carrying the stretcher 200, the user 202 may drag the stretcher 200 by the handle extension 211c. As shown in this embodiment, the handle extension 211c may further include a pull handle component 211d and an intermediate pull handle component 211e that the user 202 may grip when dragging the stretcher 200.

FIG. 10 shows four users 202 carrying the stretcher 200 by four of the handle extensions 210a. Additional combinations of users 202 and/or handle extensions 210a, 211a, 211c may be capable of, and usable for, transporting the stretcher 200. In the embodiment shown in FIG. 10, the victim 208 is secured to the top surface 204 by a first securing strap 214a and a second securing strap 214b. The first and second securing straps 214a, 214b each have a first longitudinal end and a second longitudinal end. The first longitudinal ends of the first and second securing straps 214a, 214b are connected to the body 203.

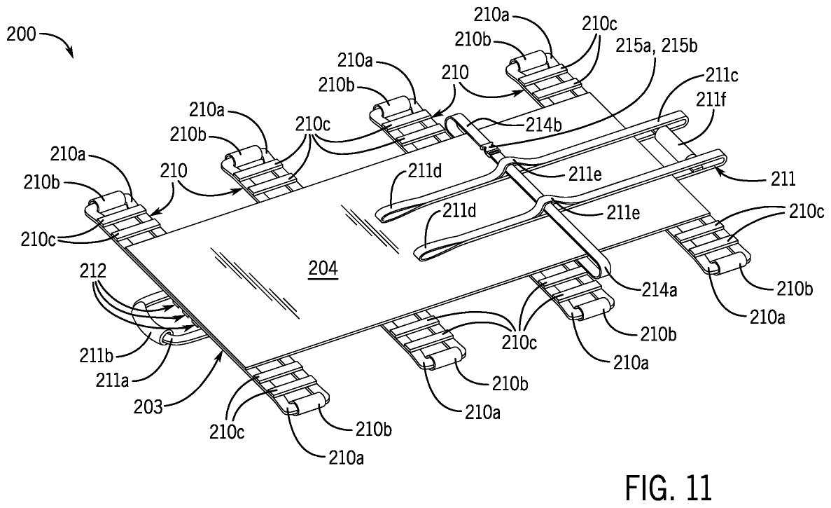

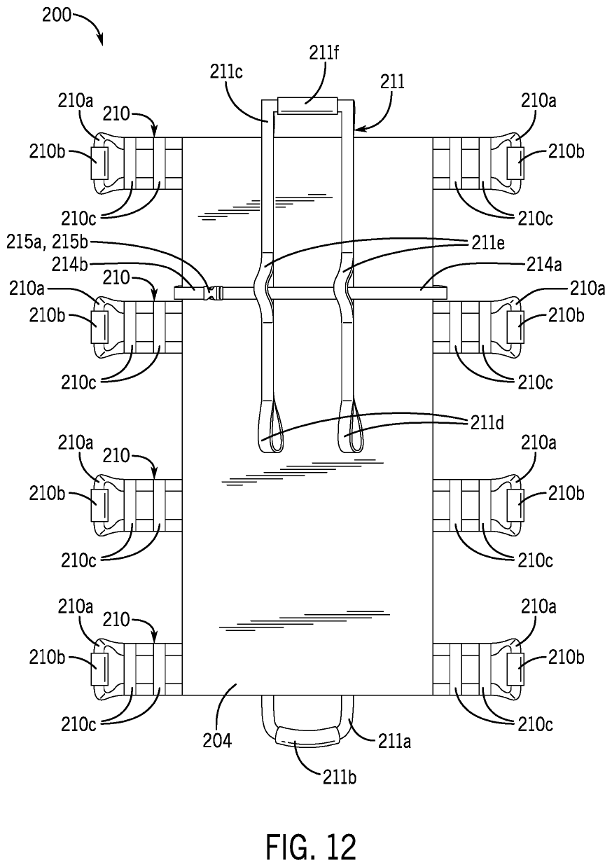

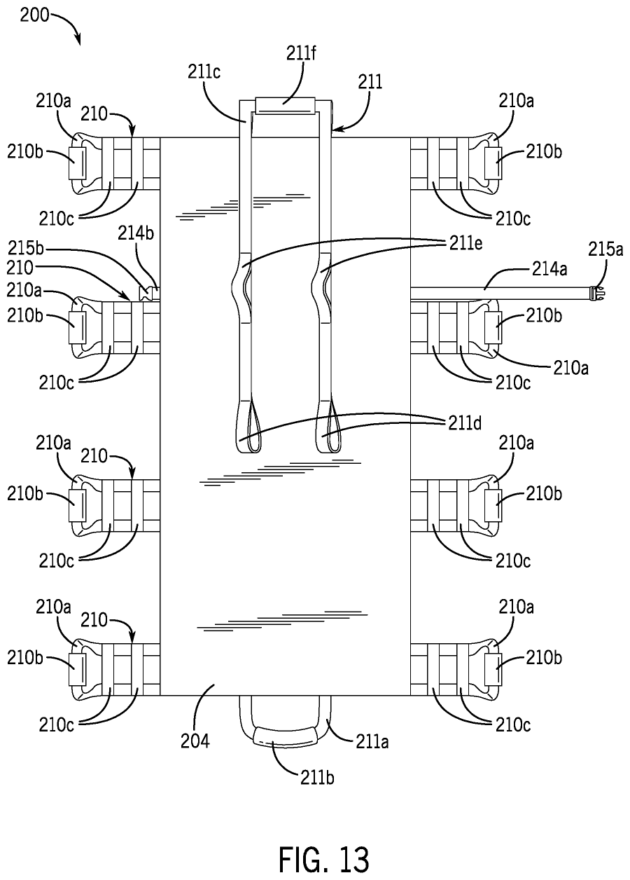

FIGS. 11-15 show the first and second securing straps 214a, 214b in both a secured position (shown in FIGS. 11-12) and an unsecured position (shown in FIGS. 13-15). In the embodiment shown, a first buckle component 215a is attached to the second longitudinal end of the first securing strap 214a, and a corresponding, second buckle component 215b is attached to the second longitudinal end of the second securing strap 214b. In this embodiment, the first and second securing straps 214a, 214b are brought into the secured position by mating the first buckle component 215a with the second buckle component 215b. However, in other embodiments, other means of bringing the first and second securing straps 214a, 214b into the secured position may be employed.

FIGS. 11-15 further show the top surface 204 in greater detail. In this embodiment, eight handle extensions 210a, one handle extension 211a, and one handle extension 211c extend from underneath the body 203. In other embodiments, a different number of handle extensions 210a, 211a, 211c may be included. In the embodiment shown, the handle extension 210a includes one handle component 210b and three intermediate handle components 210c. Alternatively, in other embodiments, the handle extension 210a may include a different number of handle components 210b and/or intermediate handle components 210c. In the embodiment shown, the handle extension 210a forms a relative U shape, having two legs connected by a bend portion. In this embodiment, the handle component 210b occupies the bend portion, while the intermediate handle components 210c traverse the space between the two legs, perpendicularly attaching to each leg. In this embodiment, the handle components 210b are comprised of foam, whereas the intermediate handle components 210c are comprised of webbed material. In the embodiment shown, the handle extension 211a also forms a U shape, having two legs connected by a bend portion, and the handle component 211b occupies the bend portion. The handle extension 211c forms a relative H shape, having two straps, connected by the handle component 211f. In this embodiment, the handle components 211b, 211f are comprised of foam. Additionally, in the embodiment shown, the handle extension 211c includes two pull handle components 211d and two intermediate pull handle components 211e. However, in other embodiments, more or fewer pull handle components 211d or intermediate pull handle components 211e may be included. In this embodiment, the handle component 211d is formed by folding the handle extension 211c over at a longitudinal end to form a loop for the user 202 to grip. To form the intermediate pull handle component 211e in this embodiment, a webbed strap, having two longitudinal ends, is attached to a strap of the handle extension 211c by the two longitudinal ends, such that the webbed strap forms a handle that the user 202 may grip when dragging the stretcher.

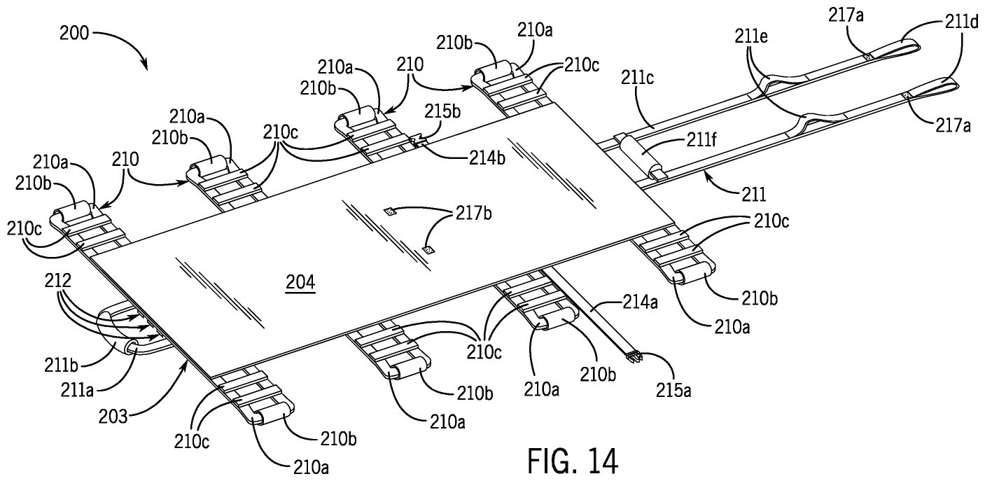

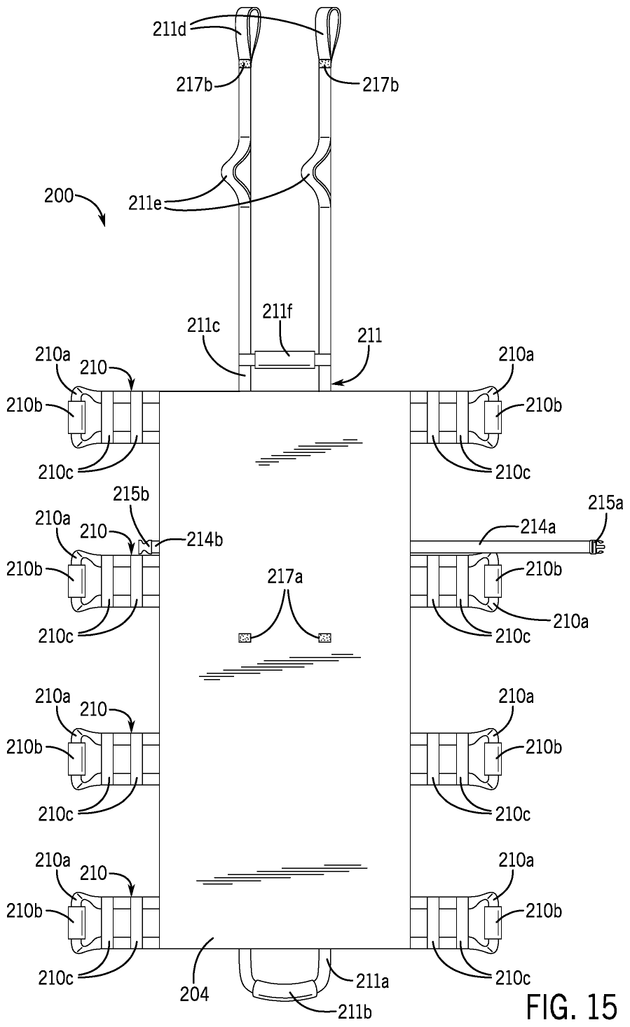

When it is intended for the victim 208 to be carried in the stretcher 200 and it is not necessary to secure the victim 208, the stretcher 200 may be arranged as shown in FIGS. 11-12. Here, the handle extension 211c is folded relatively flush against the top surface 204, and the first and second securing straps 214a, 214b are in the secured position, also relatively flush against the top surface 204. In this embodiment, the first and second securing straps 214a, 214b pass through the intermediate pull handle components 211e when placed into the secured position. To maintain the relatively flush position against the top surface 204 as the stretcher 200 is transported, the handle extension 211c may removably attach to the top surface 204. In certain embodiments, a first hook-and-loop patch 217a may attach to the handle extension 211c, and a corresponding, second hook-and-loop patch 217b may attach to the top surface 204. The embodiment shown in FIGS. 14-15 includes two of the first hook-and-loop patches 217a, positioned on the handle extension 211c, adjacent to the pull handle components 211d, and two of the second hook-and-loop patches 217b, positioned on the top surface 204, such that when the first hook and loop patches 217a are mated with the corresponding, second hook and loop patches 217b, the handle extension 211c rests relatively flush against the top surface 204. In this manner of use, the victim 208 may be placed on the stretcher 200, over the handle extension 211c and the first and second securing straps 214a, 214b, and carried in the stretcher 200 without the unused handle extension 211c or the first and second securing straps 214a, 214b dangling freely from the body 203.

In another manner of use, as shown in FIG. 13, the handle extension 211c may be secured relatively flush against the top surface 204 as described above, while the securing straps 214a, 214b hang in an unsecured position. Thus, a victim 208 needing to be both carried in the stretcher 200 and secured to the top surface 204 may be placed on the top surface 204, over the handle extension 211c, and then secured by the first and second securing straps 214a, 214b, as shown in FIG. 10. In a further alternative, as shown in FIGS. 14-15, both the handle extension 211c and the first and second securing straps 214a, 214b may extend outwardly from the body 203, allowing a victim 208, positioned on the top surface 204, to be both secured by the first and second securing straps 214a, 214b and dragged in the stretcher 200 by the handle extension 211c, such as in an emergency situation where there is insufficient time to gather a group of users 202, and it is desirable for a single user 202 to move the victim.

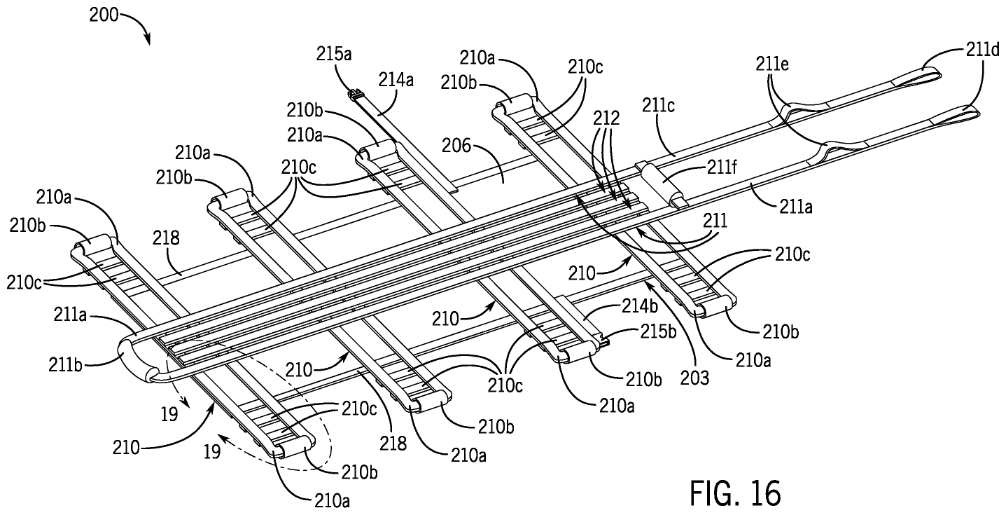

FIGS. 16-19 show the bottom surface 206 in greater detail. In the embodiment shown, the body 203 is relatively rectangular, having a pair of opposing long side edges and a pair of opposing short side edges. A side perimeter strap 218 attaches to each long side edge. Here again, the above reference to the body 203 being rectangular can be considered for reference purposes only so that, in certain embodiments, the bottom surface 206 may take on a non-rectangular shape, and alternative or additional perimeter straps may be attached to or additional edges, or to the short side edges of the embodiment shown. In this embodiment, the side perimeter straps 218 are stitched to the bottom surface 206, although in other embodiments, other attachment means may be employed. In the embodiment shown in FIGS. 16-18, the first and second securing straps 214a, 214b are stitched to the bottom surface 206 and to the side perimeter straps 218 where the first and second securing straps 214a, 214b intersect the side perimeter straps 218. In alternative embodiments, the first and second securing straps 214a, 214b may connect to the body 203 by means other than stitching.

In some embodiments, structural webbing is further included on the body 203. In the embodiment shown in FIGS. 16-19, the structural webbing 210 is comprised of pairs of straps that traverse the space between the long side edges and then extend beyond the body 203 to form the relatively U-shaped handle extensions 210a. In the embodiment shown, the structural webbing 210 is partially stitched to the bottom surface 206 and partially extended beyond the bottom surface 206. In other embodiments, the structural webbing 210 may be confined to the body 203, without extending further. Additionally, in certain embodiments, the structural webbing 210 may be arranged in a different configuration.

In the embodiment shown, skid plate webbing 211, 212 is shown connected to the bottom surface 206. In this embodiment, the skid plate webbing 211, 212 is arranged as a series of straps, approximately one-and-a-half inches wide at approximately one-and-an-eighth inch spacing, positioned longitudinally along the bottom surface 206. In alternate embodiments, the skid plate webbing 211, 212 may vary in width and spacing. For instance, the series of straps may comprise approximately two inch straps at approximately one inch spacing. Regardless of the shape of the body 203 or the specific dimensions of the skid plate webbing 211, 212, the longest dimension of the webbing extends in the direction that the stretcher 200 is dragged in ordinary use, when bearing a victim 208.

The skid plate webbing 211, 212 may either be confined to the bottom surface 206 or extend beyond the bottom surface 206. In the embodiment shown, the skid plate webbing straps 211 extend beyond the bottom surface, forming the handle extensions 211a, 211c, whereas the skid plate webbing straps 212 remain confined to the bottom surface 206. In this embodiment, the extended skid plate webbing 211 consists of two straps and the confined skid plate webbing 212 consists of three straps, positioned between the extended skid plate webbing 211. However, in other embodiments, the number of extended skid plate webbing straps 211 and confined skid plate webbing straps 212 may vary, along with the order in which the skid plate webbing straps 211, 212 are positioned relative to one another. For instance, an alternate embodiment may comprise a single extended skid plate webbing strap 211 surrounded by two confined skid plate webbing straps 212 on either side, similar to the arrangement of skid plate webbing 111, 112 in the previous embodiment. In the embodiment shown, the skid plate webbing 211, 212 is stitched over the structural webbing 210, maximizing the ease with which the stretcher 200 may be dragged along a ground surface and minimizing damage to the structural webbing 210.

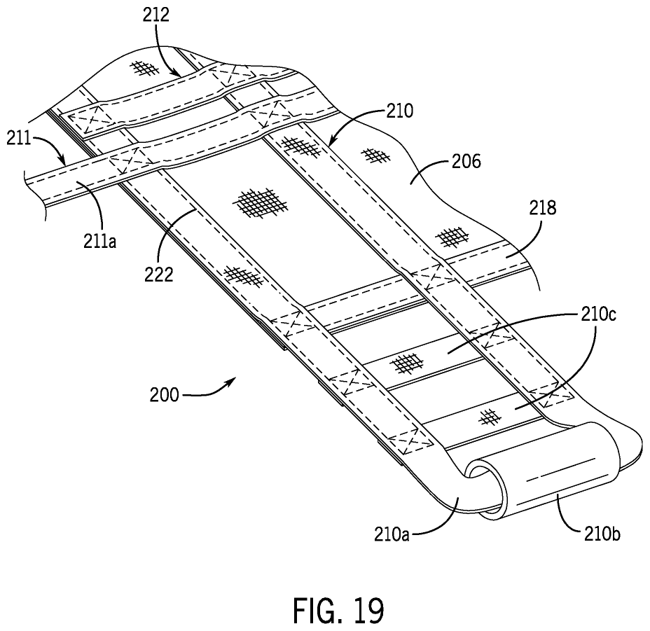

As referenced above, in the embodiment shown in FIGS. 16-19, the handle extensions 210a, 211a, 211c are shown as continuous extensions of the connected portions of the structural and skid plate webbing 210, 211. In this embodiment, the skid plate webbing 211, 212 is connected to the bottom surface 206 by stitching. The stitching 222 at a corner of the bottom surface 206 is shown in detail in FIG. 19. Here, a portion of the skid plate webbing 211, 212 is shown stitched to the bottom surface 206 and to the structural webbing 210 where the skid plate webbing 211, 212 intersects the structural webbing 210. Additionally, a portion of the structural webbing 210 is shown, the structural webbing 210 stitched to the bottom surface 206, and to the side perimeter strap 218 where the structural webbing 210 intersects the side perimeter strap 218.

Alternatively, the elements stitched to the bottom surface 206 in this embodiment may, in other embodiments, be connected by means other than stitching. In a further alternative, the handle extensions 210a, 211a, 211c may be discrete elements, independently attached to the body 203, rather than continuous extensions of the structural webbing 210 and the skid plate webbing 211. For example, the handle extensions 210a, 211a, 211c may be stitched, or otherwise attached, directly to one or both of the surfaces 204, 206, to one or both of the forms of webbing 210, 211, to the side perimeter straps 218, or to any combination thereof.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A stretcher comprising:
a flexible body having a first surface and a second surface; and
skid plate webbing connected to the second surface.

2. A stretcher as recited in claim 1 further comprising structural webbing connected to the body.

3. A stretcher as recited in claim 2 wherein the skid plate webbing and the structural webbing each comprise a plurality of straps.

4. A stretcher as recited in claim 3 wherein at least one of the plurality of straps further comprises a handle extension extending beyond the body, the handle extension including a handle component.

5. A stretcher as in claim 4 further comprising at least one hook-and-loop patch attached to at least one of the handle extensions and at least one corresponding hook-and-loop patch attached to the first surface of the body.

6. A stretcher as in claim 1 wherein the body has at least four sides, further comprising at least one handle attached to one side and at least one handle attached to a different side.

7. A stretcher as in claim 6 wherein the handles are formed of a webbed material and connected to the sides by stitching.

8. A stretcher as recited in claim 2 wherein the structural webbing and the skid plate webbing are connected to the body by stitching.

9. A stretcher as recited in claim 2 wherein the structural webbing and the skid plate webbing intersect at a contact point, at which contact point the structural webbing and the skid plate webbing are stitched together.

10. A stretcher comprising:
a flexible body having a first surface, and a second surface;
structural webbing connected to the second surface;
skid plate webbing connected to the second surface and at least partially overlapping the structural webbing; and
one or more contact points where the skid plate webbing overlaps the structural webbing.

11. A stretcher as recited in claim 10 wherein the structural webbing comprises a plurality of structural webbing straps positioned in an X shape.

12. A stretcher as recited in claim 11 wherein at least one of the plurality of structural webbing straps extends beyond the body.

13. A stretcher as recited in claim 10 wherein flexible body has a rectangular shape extending lengthwise in a longitudinal direction, and wherein the structural webbing comprises a plurality of structural webbing straps positioned transversely to the longitudinal direction.

14. A stretcher as recited in claim 13 wherein at least one of the plurality of structural webbing straps extends beyond the body.

15. A stretcher as recited in claim 10 wherein the skid plate webbing comprises a plurality of skid plate webbing straps extending in the longitudinal direction.

16. A stretcher as recited in claim 15 wherein at least one of the plurality of skid plate webbing straps extends beyond the body.

17. A stretcher as in claim 10 wherein the structural webbing and the skid plate webbing are connected to the second surface by stitching.

18. A stretcher as in claim 10 wherein the structural webbing and the skid plate webbing are connected by stitching at the one or more contact points.

19. A stretcher comprising:
a flexible body having a rectangular shape, a first surface, and a second surface, the rectangular shape comprising two longer, lateral sides and two shorter, end sides;
structural webbing connected to the second surface, the structural webbing comprised of a plurality of structural webbing straps positioned in an X shape, at least one of the plurality of structural webbing straps extending beyond the body;
skid plate webbing connected to the second surface and at least partially overlapping the structural webbing, the skid plate webbing comprised of a plurality of skid plate webbing straps positioned parallel to the longer, lateral sides, at least one of the plurality of skid plate webbing straps extending beyond the body;
one or more contact points formed where the skid plate webbing overlaps the structural webbing;
at least one handle component located on each of the structural webbing straps that extend beyond the body; and
at least one handle component located on each of the skid plate webbing straps that extend beyond the body.

20. A stretcher as recited in claim 19 wherein the structural webbing straps and the skid plate webbing straps are stitched together at the one or more contact points.

21. A method of manufacturing a stretcher having a flexible body, the body having a first surface, and a second surface, the method comprising:
attaching structural webbing to the body, and
attaching skid plate webbing to the second surface.

22. A method as recited in claim 21 wherein the flexible body has a rectangular shape extending lengthwise in a longitudinal direction, and wherein the attaching of the skid plate webbing comprises attaching, at least partially, a plurality of straps extending in the longitudinal direction.

23. A method as recited in claim 22 further comprising sizing one or more of the plurality of straps to extend beyond the body in the longitudinal direction.

24. A method as recited in claim 23 further comprising forming a handle component in at least one of the straps sized to extend beyond the body in the longitudinal direction.

25. A method as recited in claim 23 further comprising attaching a handle component to at least one of the straps sized to extend beyond the body in the longitudinal direction.

26. A method as recited in claim 21 wherein the attaching of the skid plate webbing is accomplished by stitching.

27. A method as recited in claim 21 further comprising forming the stretcher into a roll and sizing the roll to fit within a set of external straps connected to a piece of first responder equipment.
